(19) United States
(12) Patent Application Publication
(10) Pub. No.: US 2007/0253489 A1
(43) Pub. Date: Nov. 1, 2007

(54) IMAGE PROCESSING CIRCUIT AND METHOD

(76) Inventors: Po-Wei Chao, Taipei Hsien (TW); Hsin-Ying Ou, Hsin-Chu City (TW); Ching-Hua Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/739,107

(22) Filed: Apr. 24, 2007

(30) Foreign Application Priority Data
Apr. 28, 2006 (TW) 095115348

(51) Int. Cl. H04N 5/91; H04N 11/02

(52) U.S. Cl. 375/240.21; 386/123

(57) ABSTRACT

An image processing circuit includes: a motion detector for detecting motion of an image carried by a first video signal to generate a selection signal, where regarding a pixel of the image, the motion detector generates a selection value in the selection signal, the selection value corresponding to the pixel; a field up-sampling filter for performing chroma up-sampling of the pixel on a field in a second video signal corresponding to the first video signal; a frame up-sampling filter for performing chroma up-sampling of the pixel on a frame in the second video signal; and a switching unit utilized for inputting the second video signal into one of the field up-sampling filter and the frame up-sampling filter according to the selection value to perform chroma up-sampling of the pixel.

### BACKGROUND OF THE INVENTION

1. Field of the Invention

The present invention relates to image processing, and more particularly, to image processing circuits and methods that can be utilized for performing chroma up-sampling.

2. Description of the Prior Art

According to characteristics of the human eye and some assumptions related to photoreception of the human eye, chroma information recorded in many image compression formats is less than luminance information therein in order to improve the compression rate of video data of acceptable image quality for the human eye, so that storage or transmission efficiency thereof can be improved. For example, in a video processing procedure of a Digital Versatile Disc (DVD) player, transformations between any two formats out of “4:4:4” format, “4:2:2” format, and “4:2:0” format are involved. In the three formats mentioned above, the “4:4:4” format includes the most chroma information, and the “4:2:0” format includes the least chroma information. Therefore, the “4:2:0” format provides the best compression rate in contrast to the other two formats.

The “4:4:4” format mentioned above means: for every four luminance samples Y, there exists four chroma samples Cb and four chroma samples Cr corresponding to the four luminance samples Y. In addition, the “4:2:2” format means: for every four luminance samples Y, there exists two chroma samples Cb and two chroma samples Cr corresponding to the four luminance samples Y. It is noted that the number of the chroma samples Cb and the number of the chroma samples Cr along a horizontal direction of a picture in the “4:2:2” format are respectively reduced to half of those in the “4:4:4” format. Additionally, the number of the chroma samples Cb and the number of the chroma samples Cr in the “4:2:0” format are respectively reduced to half of those in the “4:4:4” format along either a horizontal direction or a vertical direction of a picture. The relationships between the three formats mentioned above are well known in the art and therefore not explained in detail here.

When an MPEG decoder of the DVD player performs chroma up-sampling such as converting video data of a “4:2:0” format to video data of a “4:2:2” format, additional chroma samples Cb and Cr should be generated along a vertical direction of a picture. If the MPEG decoder utilizes a frame interpolation method to perform the format conversion mentioned above, chroma errors will easily occur regarding motion images. If the MPEG decoder utilizes a field interpolation method to perform the format conversion mentioned above, chroma errors will also easily occur regarding still images when a frame composed of an odd field and an even field is generated by this format conversion.

### SUMMARY OF THE INVENTION

It is an objective of the claimed invention to provide image processing circuits and methods capable of being utilized for performing chroma up-sampling.

It is another objective of the claimed invention to provide image processing circuits and methods, to decrease or eliminate errors generated due to performing chroma up-sampling.

According to one embodiment of the claimed invention, an image processing circuit capable of being utilized for performing chroma up-sampling is disclosed. The image processing circuit comprises: a motion detector for detecting motion of an image carried by a first video signal to generate a selection signal, and generating a selection value in the selection signal, the selection value corresponding to a pixel of the image; a field up-sampling filter for performing chroma up-sampling of the pixel on a field in a second video signal corresponding to the first video signal; a frame up-sampling filter for performing chroma up-sampling of the pixel on a frame in the second video signal corresponding to the first video signal; and a switching unit, coupled to the motion detector, the field up-sampling filter, and the frame up-sampling filter, the switching unit being utilized for inputting the second video signal into one of the field up-sampling filter and the frame up-sampling filter according to the selection value to perform chroma up-sampling of the pixel.

According to one embodiment of the claimed invention, an image processing method capable of being utilized for performing chroma up-sampling is disclosed. The image processing method comprises the following steps: detecting motion of an image carried by a first video signal to generate a selection signal, and generating a selection value in the selection signal, the selection value corresponding to a pixel of the image; and according to the selection value, executing at least one step of the following steps: performing chroma up-sampling of the pixel on a field in a second video signal corresponding to the first video signal; and performing chroma up-sampling of the pixel on a frame in the second video signal corresponding to the first video signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image processing circuit according to one embodiment of the present invention.

FIG. 2 is a diagram of an image processing circuit according to one embodiment of the present invention.

FIG. 3 is a diagram of an image processing circuit according to one embodiment of the present invention.

FIG. 4 is a diagram of an image processing circuit according to one embodiment of the present invention.

### DETAILED DESCRIPTION

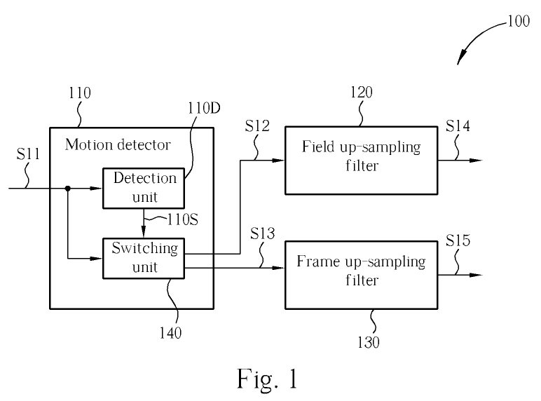

Please refer to FIG. 1. FIG. 1 is a diagram of an image processing circuit 100 according to one embodiment of the present invention. The image processing circuit 100 can be utilized for performing chroma up-sampling such as converting video data of a “4:2:0” format to video data of a “4:2:2” format or a “4:4:4” format. The image processing circuit 100 comprises a motion detector 110, a field up-sampling filter 120, and a frame up-sampling filter 130. The image processing circuit 100 further comprises a switching unit 140, coupled to the motion detector 110, the field up-sampling filter 120, and the frame up-sampling filter 130, where the switching unit 140 of this embodiment is positioned in the motion detector 110. In general, at least one portion of the image processing circuit 100 can be integrated into the same module.

The motion detector 110 of this embodiment is capable of detecting motion of an image carried by a video signal S11 by utilizing a detection unit 110D positioned in the motion detector 110, to generate a selection signal 110S for controlling the switching unit 140. Regarding a pixel of the image, the motion detector 110 of this embodiment is also capable of generating a selection value in the selection signal 110S by utilizing the detection unit 110D, where the selection value corresponds to the pixel. According to this embodiment, through controlling the switching unit 140 by utilizing the selection signal 110S, the field up-sampling filter 120 is capable of performing chroma up-sampling of the pixel on a field in the video signal S11, and the frame up-sampling filter 130 is capable of performing chroma up-sampling of the pixel on a frame in the video signal S11.

The switching unit 140 is utilized for inputting the video signal S11 into either the field up-sampling filter 120 or the frame up-sampling filter 130 according to the selection value to perform chroma up-sampling of the pixel. If the selection value corresponds to a motion image, the switching unit 140 switches the video signal S11 to be inputted into the field up-sampling filter 120. In this situation, the input signal S12 of the field up-sampling filter 120 is the video signal S11. If the selection value corresponds to a still image, the switching unit 140 switches the video signal S11 to be inputted into the frame up-sampling filter 130. In this situation, the input signal S13 of the frame up-sampling filter 130 is the video signal S11. As a result, the embodiment of the present invention dynamically inputs the video signal S11 into either the field up-sampling filter 120 or the frame up-sampling filter 130 by utilizing the pixel-based control as mentioned above, in order to select the frame interpolation method or the field interpolation method to process the pixel to be up-sampled, so errors generated due to performing chroma up-sampling according to the prior at can be corrected or eliminated.

According to this embodiment, the video signal S11 carries video data of the “4:2:0” format, and both the video signal S14 outputted by the field up-sampling filter 120 and the video signal S15 outputted by the frame up-sampling filter 130 carry video data of the “4:2:2” format. In addition, the video signals S14 and S15 can be derived within the image processing circuit 100 or derived from another circuit outside the image processing circuit 100 for further utilization.

According to a variation of this embodiment, the video signal S11 carries video data of the “4:2:0” format, and both the video signals S14 and S15 carry video data of the “4:4:4” format. In addition, the video signals S14 and S15 can be selected out by utilizing a multiplexer (not shown) coupled to the selection signal 110S, for further utilization by a latter stage of the image processing circuit 100.

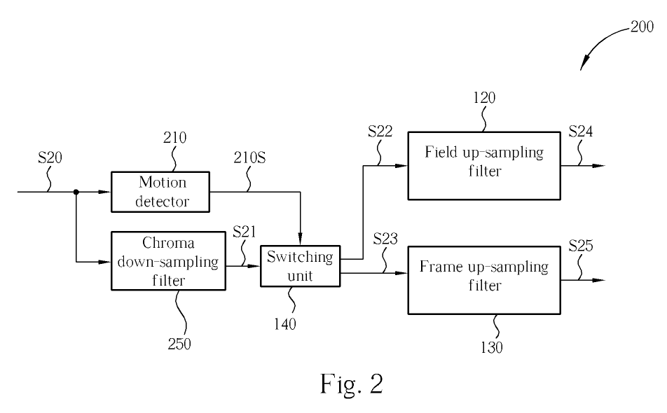

Please refer to FIG. 2. FIG. 2 is a diagram of an image processing circuit 200 according to one embodiment of the present invention. In addition to the field up-sampling filter 120, the frame up-sampling filter 130, and the switching unit 140 mentioned above, the image processing circuit 200 further comprises a motion detector 210 and a chroma down-sampling filter 250. In contrast to the embodiment shown in FIG. 1, the switching unit 140 of this embodiment is positioned outside the motion detector 210. The motion detector 210 detects motion of an image carried by a video signal S20 to generate a selection signal 210S for controlling the switching unit 140. Regarding a pixel of the image, the motion detector 210 of this embodiment generates a selection value in the selection signal 210S, where the selection value corresponds to the pixel.

In addition, the chroma down-sampling filter 250 performs chroma down-sampling on the video signal S20 to generate a video signal 21. According to this embodiment, through controlling the switching unit 140 by utilizing the selection signal 210S, the field up-sampling filter 120 is capable of performing chroma up-sampling of the pixel on a field in the video signal S21, and the frame up-sampling filter 130 is capable of performing chroma up-sampling of the pixel on a frame in the video signal S21.

The switching unit 140 is utilized for inputting the video signal S21 into either the field up-sampling filter 120 or the frame up-sampling filter 130 according to the selection value to perform chroma up-sampling of the pixel. If the selection value corresponds to a motion image, the switching unit 140 switches the video signal S21 to be inputted into the field up-sampling filter 120. In this situation, the input signal S22 of the field up-sampling filter 120 is the video signal S21. If the selection value corresponds to a still image, the switching unit 140 switches the video signal S21 to be inputted into the frame up-sampling filter 130. In this situation, the input signal S23 of the frame up-sampling filter 130 is the video signal S21.

As it is likely that the video signal S20 will have errors generated during previously performed chroma up-sampling, the image processing circuit 200 may re-perform chroma up-sampling. The image processing circuit 200 of this embodiment is capable of performing chroma down-sampling on the video signal S20 by utilizing the chroma down-sampling filter 250 to generate the video signal S21, and is capable of dynamically inputting the video signal S21 into either the field up-sampling filter 120 or the frame up-sampling filter 130 by utilizing the pixel-based control as mentioned above, in order to select one of the frame interpolation method and the field interpolation method to process the pixel to be up-sampled, so errors generated due to performing chroma up-sampling according to the prior art can be corrected or eliminated.

According to this embodiment, the video signal S20 carries video data of the “4:2:2” format, the video signal S21 carries video data of the “4:2:0” format, and both the video signal S24 outputted by the field up-sampling filter 120 and the video signal S25 outputted by the frame up-sampling filter 130 carry video data of the “4:2:2” format. In addition, the video signals S24 and S25 can be derived within the image processing circuit 200 or derived from another circuit outside the image processing circuit 200, for further utilization.

According to a variation of this embodiment, the video signal S20 carries video data of the “4:4:4” format, the video signal S21 carries video data of the “4:2:0” format, and both the video signals S24 and S25 carry video data of the “4:4:4” format.

According to another variation of this embodiment, the format of the video data carried by the video signals S24 and S25 can be different from the format of the video data carried by the video signal S20. For example, the video signal S20 carries video data of the “4:4:4” format, and both the video signals S24 and S25 carry video data of the “4:2:2” format. In another example, the video signal S20 carries video data of the “4:2:2” format, and both the video signals S24 and S25 carry video data of the “4:4:4” format.

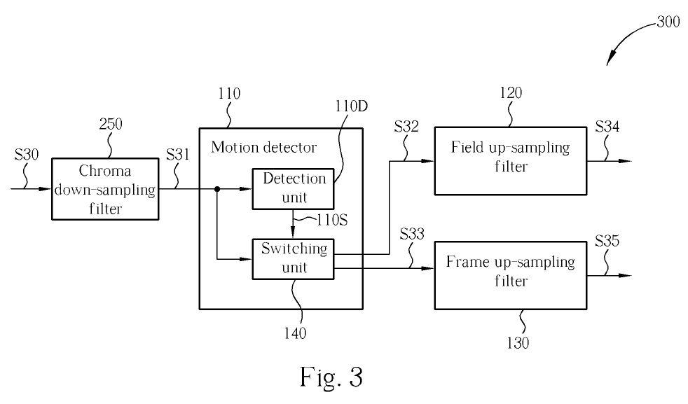

Please refer to FIG. 3. FIG. 3 is a diagram of an image processing circuit 300 according to one embodiment of the present invention. The image processing circuit 300 comprises the chroma down-sampling filter 250 shown in FIG. 2 and the components within the image processing circuit 100 shown in FIG. 1, where the video signals S31, S32, S33, S34, and S35 respectively correspond to the video signals S11, S12, S13, S14, and S15 shown in FIG. 1. Similar descriptions for the operations of these components mentioned above are not repeated here.

According to this embodiment, the video signal S30 carries video data of the “4:2:2” format, the video signal S31 carries video data of the “4:2:0” format, and both the video signal S34 outputted by the field up-sampling filter 120 and the video signal S35 outputted by the frame up-sampling filter 130 carry video data of the “4:2:2” format. In addition, the video signals S34 and S35 can be derived within the image processing circuit 300 or derived from another circuit outside the image processing circuit 300, for further utilization.

According to a variation of this embodiment, the video signal S30 carries video data of the “4:4:4” format, the video signal S31 carries video data of the “4:2:0” format, and both the video signals S34 and S35 carry video data of the “4:4:4” format.

According to another variation of this embodiment, the format of the video data carried by the video signals S34 and S35 can be different from the format of the video data carried by the video signal S30. For example, the video signal S30 carries video data of the “4:4:4” format, and both the video signals S34 and S35 carry video data of the “4:2:2” format. In another example, the video signal S30 carries video data of the “4:2:2” format, and both the video signals S34 and S35 carry video data of the “4:4:4” format.

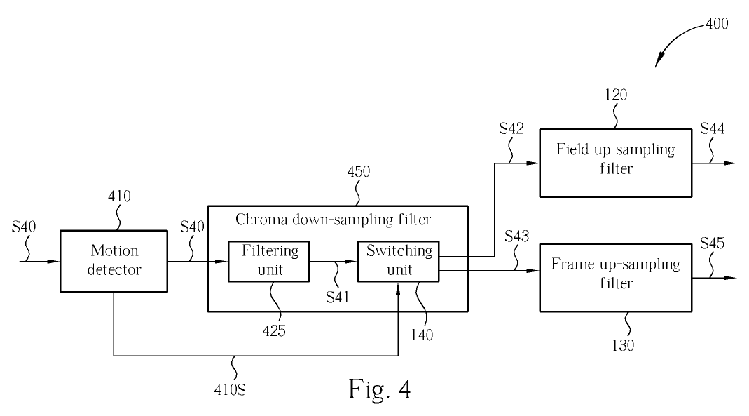

Please refer to FIG. 4. FIG. 4 is a diagram of an image processing circuit 400 according to one embodiment of the present invention. This embodiment is a variation of the embodiment shown in FIG. 2, where the video signals S40, S41, S42, S43, S44, and S45 respectively correspond to the video signals S20, S21, S22, S23, S24, and S25, and the selection signal 410S corresponds to the selection signal 210S. The motion detector 410 of this embodiment is capable of bypassing the video signal S40 for use by the chroma down-sampling filter 450, and is also capable of performing the same operations of the motion detector 210. In addition, the switching unit 140 of this embodiment is positioned in the chroma down-sampling filter 450, where the operations of the filtering unit 425 within the chroma down-sampling filter 450 are similar to those of the chroma down-sampling filter 250. Similar descriptions are not repeated here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing circuit capable of being utilized for performing chroma up-sampling, the image processing circuit comprising:
a motion detector for detecting motion of an image carried by a video signal to generate a selection value corresponding to a pixel of the image;
a field up-sampling filter for performing chroma up-sampling of the pixel on a field corresponding to the video signal;
a frame up-sampling filter for performing chroma up-sampling of the pixel on a frame corresponding to the video signal; and
a switching unit, coupled to the motion detector, the field up-sampling filter, and the frame up-sampling filter, the switching unit being utilized for inputting the video signal into the field up-sampling filter or the frame up-sampling filter according to the selection value to perform chroma up-sampling of the pixel.

2. The image processing circuit of claim 1, further comprising:
a chroma down-sampling filter for performing chroma down-sampling on the video signal before inputting the video signal into the field up-sampling filter or the frame up-sampling filter according to the selection value to perform chroma up-sampling.

3. The image processing circuit of claim 2, wherein the video data carried by the video signal before chroma down-sampling is of the “4:2:0” format.

4. The image processing circuit of claim 2, wherein the video data carried by the video signal before chroma down-sampling is of the “4:2:2” format.

5. The image processing circuit of claim 2, wherein the video data carried by the video signal before chroma down-sampling is of the “4:4:4” format.

6. The image processing circuit of claim 1, wherein the video data carried by the video signal after chroma up-sampling is of the “4:2:2” format.

7. The image processing circuit of claim 1, wherein the video data carried by the video signal after chroma up-sampling is of the “4:4:4” format.

8. The image processing circuit of claim 1, wherein if the selection value corresponds to a motion image, the switching unit switches the video signal to be inputted into the field up-sampling filter.

9. The image processing circuit of claim 1, wherein if the selection value corresponds to a still image, the switching unit switches the video signal to be inputted into the frame up-sampling filter.

10. The image processing circuit of claim 1, wherein at least one portion of the image processing circuit is integrated into the same module.

11. An image processing method capable of being utilized for performing chroma up-sampling, the image processing method comprising the following steps:
detecting motion of an image carried by a video signal to generate a selection value corresponding to a pixel of the image; and
according to the selection value, executing one of the following steps:
performing chroma up-sampling of the pixel on a field corresponding to the video signal; and
performing chroma up-sampling of the pixel on a frame corresponding to the video signal.

12. The image processing method of claim 11, further comprising:
performing chroma down-sampling on the video signal before according to the selection value, executing one of the following steps:
performing chroma up-sampling of the pixel on a field corresponding to the video signal; and
performing chroma up-sampling of the pixel on a frame corresponding to the video signal.

13. The image processing method of claim 12, wherein the video data carried by the video signal before chroma down-sampling is of the “4:2:0” format.

14. The image processing method of claim 12, wherein the video data carried by the video signal before chroma down-sampling is of the “4:2:2” format.

15. The image processing method of claim 12, wherein the video data carried by the video signal before chroma down-sampling is of the “4:4:4” format.

16. The image processing method of claim 11, wherein the video data carried by the video signal after chroma up-sampling is of the “4:2:2” format.

17. The image processing method of claim 11, wherein the video data carried by the video signal after chroma up-sampling is of the “4:4:4” format.

18. The image processing method of claim 11, wherein if the selection value corresponds to a motion image, the executing step performs the chroma up-sampling of the pixel on the field corresponding to the video signal.

19. The image processing method of claim 11, wherein if the selection value corresponds to a still image, the executing step performs the chroma up-sampling of the pixel on the frame corresponding to the video signal.
